(19) United States
(12) Patent Application Publication
(10) Pub. No.: US 2002/0107811 A1
(43) Pub. Date: Aug. 8, 2002

(54) Use of time-stamps and digital signatures

(76) Inventors: Sandeep Jain, Belmont, CA (US); Sudheer Thakur, Belmont, CA (US); Yat-Chi (Andy) Yeung, Belmont, CA (US)

Correspondence Address: HICKMAN PALERMO TRUONG & BECKER LLP, 1600 Willow Street, San Jose, CA, 95125-5106, US

(21) Appl. No.: 09/755,385

(22) Filed: Jan. 5, 2001

Related U.S. Application Data
(60) Provisional application No. 60/175,062, filed on Jan. 7, 2000.

(51) Int. Cl. G06F 17/60

(52) U.S. Cl. 705/64

(57) ABSTRACT

Techniques are provided for utilizing time-stamps and digital signatures to be sent with the messages communicated between partners of a trading community. In one embodiment, upon a transaction is initiated, a time-stamp is automatically embedded in a message of the transaction. A digital signature of the sender also accompanies the message for the message recipient to authenticate that the transaction is initiated by an authentic sender, and not an imposter. As soon as the message is propagated, a monitor process monitors activities acted upon the message. The monitor process receives receipt acknowledgement and consumption acknowledgment from each site that receives the message. Based on the initiated time-stamp and relevant times, the monitor process determines whether the message is received or consumed within a predetermined time limit. If the message is not received or not consumed within the predetermined time limit, then the monitor process raises an exception, which usually involves human intervention. Upon receiving the message, the recipient proceeds to act on the message only if the recipient can authenticate the message. The recipient, also based on the embedded time-stamp, determines if the message is received within an allowable time divergence. If the message is received within the allowable time divergence, then the recipient accepts the message. However, if the message is not received within the allowable time divergence, then the recipient raises an exception, including, for example, rejecting the message.

### FIELD OF THE INVENTION

The present invention relates generally timing in business transactions and, more specifically, to utilizing time-stamps and digital signatures that are sent with messages communicated between members of a trading community.

### BACKGROUND OF THE INVENTION

Timing in business transactions is important. For example, a customer, after placing an order to a supplier, can rely on, and thus trust, the supplier if the customer knows when to expect to receive the ordered goods from the supplier. In order for the supplier to fulfill his duty, the supplier must receive the purchase order in due time. In various situations, the business parties also rely on the order time and the delivery time to resolve disputes as to the binding time of the transactions between the parties.

The timing of the transaction is an important element with regards to contractual and legal implications. Some transactions carry contractually binding agreements; for example, a Purchase Order may be considered a legally binding document, and therefore the timing of the transaction is an important factor when determining when that liability began. Additionally, if a particular action has not taken place by a specific time, the original timing of the transaction may be used to resolve any disputes.

In e-commerce environments in which trading parties often use computers to automate business transactions, the parties rely on clocks built in the computers to indicate the timing of the various events that occur in transactions. In these situations, the computer of the customer is used, for example, to initiate an order to the supplier. The computer of the supplier, upon receiving the order, sends a response acknowledging receipt of the order. The order time and the response time are indicated by the time provided by the corresponding clocks in each computer of the customer and of the supplier. However, the clock of each party's computer may vary, and, can be inaccurate. For example, the time that the customer records for placing the order may actually be later than the time that the supplier records for sending a response to the order. Additionally, the parties may reside in different parts of the world having different time zones.

Based on the foregoing, it is desirable to provide timing mechanisms and techniques on which business parties may rely in their electronically conducted business transactions.

### SUMMARY OF THE INVENTION

Techniques are provided for utilizing time-stamps and digital signatures that are sent with messages communicated between partners of a trading community. Generally, business transactions within this community performed automatically by computers. In one embodiment, upon a transaction being initiated by a computer of a sender partner, a time-stamp is automatically embedded in a message of the transaction. A digital signature of the sender also accompanies the message for the message recipient to authenticate that an authentic sender, and not an imposter, initiated the transaction. As soon as the message is propagated, a monitor process monitors activities that act upon the message. The monitor process then receives receipt acknowledgment and consumption acknowledgment from each party that receives the message. Based on the initiated time-stamp and relevant times, the monitor process determines whether the message is received or consumed within a predetermined time limit. If the message is not received or not consumed within the predetermined time limit, then the monitor process raises an exception, which usually involves human intervention.

Upon receiving the message, the recipient proceeds to act on the message only if the recipient can authenticate the message. That is, the recipient decrypts the digital signature to verify the validity of the digital signature. The recipient, also based on the embedded time-stamp, determines if the message is received within an allowable time divergence. If the message is received within the allowable time divergence, then the recipient accepts the message. However, if the message is not received within the allowable time divergence, then the recipient raises an exception, including, for example, rejecting the message. In one embodiment, a predetermined time base, such as the Greenwich Mean Time, is used in all timing calculations. Further, a trusted intermediary may be used to provide additional services to the partners of the trading community. The trusted intermediary relays messages from one partner to another partner.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an exemplary trading community in accordance with one embodiment of the invention;

FIG. 2 is a flowchart illustrating a monitor process monitoring a message being transmitted from one partner to another partner of the trading community in FIG. 1.

FIG. 3 is a flowchart illustrating that timestamps are used in business transactions between partners of the trading community of FIG. 1.

FIG. 4 is a flowchart illustrating the use of a trusted intermediary to relay messages communicated between the partners of the trading community of FIG. 1.

FIG. 5 is a block diagram of a computer system in which embodiments of the invention may be implemented.

### DETAILED DESCRIPTION OF THE PREFERRED EMBODIMENT

Techniques are provided for utilizing time-stamps and digital signatures that are automatically sent with messages communicated between partners of a trading community. Business transactions within this trading community are generally automated.

### The Trading Community

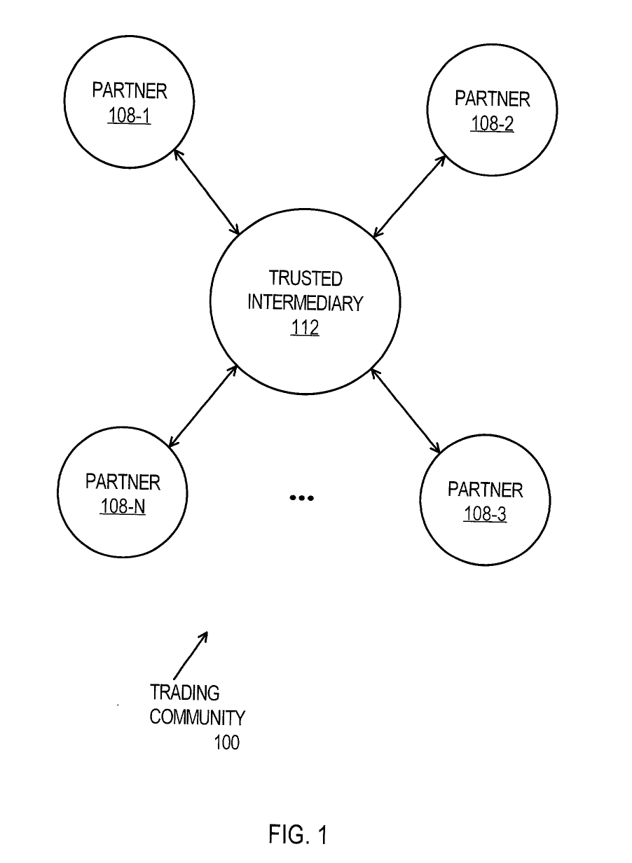

FIG. 1 shows an exemplary trading community 100 in accordance with one embodiment of the invention. Trading community 100 includes a plurality of partners 108-1 to 108-N and a trusted intermediary partner 112. Each partner 108, being a member of trading community 100, may be, for example, a customer, a supplier, a distributor, an OEM, etc. Timing in business transactions between these partners is important. For example, a customer ordering goods from a supplier would want to receive the goods by a specified date. The supplier, in order to deliver the goods by the specified date, must actually receive the purchase order in a timely manner. Further, since many of the transactions are automated without much human intervention, the initiating time and closing time of the transactions must be accurate so that the involved parties may determine the binding time of the transactions. Techniques are therefore provided such that the partners can be confident as to the timing of each transaction. To better explain the invention, the term “message” is used herein to refer to all information exchanged between partners 108 and 112. The exchanged information may be, for example, a purchase order from a buyer partner to a supplier partner or a receipt acknowledgement from the supplier partner to the buyer partner, etc.

### The Trusted Intermediary

Trusted intermediary 112 is a reliable third party via which sender partners and recipient partners 108 communicate messages. Trusted intermediary 112 provides network and business services to partners 108. These services include, for example, business logic, data mining, error recovery, etc. In various embodiments, trusted intermediary 112 may not be used, i.e., sender partners and recipient partners 108 directly communicate messages to each other.

### Authenticate The Sender

In various situations, knowing the sender is a known trading partner and not an imposter is important. Techniques are thus provided to authenticate the sender, i.e., to verify that message is indeed sent by an authentic sender. One technique for verifying the identity of the sender of a message involves the use of digital signatures. A digital signature is a code that can be attached to an electronically transmitted message to guarantee that the entity sending the message is really who it claims to be. Most digital signature mechanisms use a private digital signature key to encrypt the message digest (or method fingerprint) using the private key to generate a digital signature, and a public digital signature key to decrypt the digital signature. If the public key of party B successfully decrypts a digital signature attached to a message, then party A can be assured that party B was the sender of the message. A typically exchange of a digitally signed message would proceed as follows:

Party A provides to party B the public digital signature key of party A.

Party A creates a message to send to party B.

Party A applies a one-way hash function to the message to create a hash value.

Party A creates a digital signature by encrypting the hash value using the private digital signature key of party A.

Party A sends the message to party B, with the digital signature attached.

Party B creates a first hash value by applying the same one-way hash function to the message.

Party B creates a second hash value by decrypting the digital signature using the public digital signature key of party A.

Party B compares the first hash value to the second hash value. If the two hash values are equal, then party A was the true sender of the message.

### Time Zone Synchronization And The Time-Stamp

Partners 108 may reside in different geographic locations having different time zones. To standardize the time, in one embodiment, the Greenwich Mean Time is used as a time base for all transactions between parties 108 and 112. If the time used by any one of the parties 108 and 112 is not based on this Greenwich Mean Time, then that time is converted into the Greenwich Mean Time. Further, each time a message is transmitted, that message is automatically time-stamped using this Greenwich Mean Time. The time-stamp is then used for various purposes which will be described hereafter.

### Monitoring The Message

As soon as a message is transmitted (with the embedded time-stamp), in one embodiment, a monitor process MP monitors the activities act upon the message. Monitor process MP also determines whether each activity is performed within a predefined time limit. Monitor process MP waits to receive receipt acknowledgements that were sent from recipients of the message to sender partner 108S that sends the message. Based on the time that the message was transmitted and the time that receipt acknowledgement was received, monitor process MP determines whether the time lapse is within a time limit. According to one embodiment, the monitor process MP runs on the partner site. The time threshold values can be specified on a per message basis using the business logic rule engine.

At a receiving site, the message will be “consumed,” i.e., some actions related to the message may be performed. Monitor process MP waits for acknowledgements that the actions have been performed. Monitor process MP then determines whether each of the actions is performed within a time limit. An action related to the message includes, for example, inputting purchase order data to the ERP/MRP system of the supplier. If the message is not received within a time limit or not consumed within a time limit, then monitor process MP raises an exception. Monitor process MP, for example, sends an email to sender partner 108S or responsible personnel indicating that the message was not acknowledged within a time limit. Similarly, monitor process MP may report that a purchase order was not entered into the ERP of a supplier partner 108 in a desirable time window.

In an embodiment in which a trusted intermediary 112 used to relay the message between sender and recipient partners 108, monitor process MP also determines whether the message is received and/or transmitted at trusted intermediary 112 within a time limit. In case sender partner 108S does not receive an acknowledgement from a receiving party of the message in a specified time, monitor process MP also raises an exception.

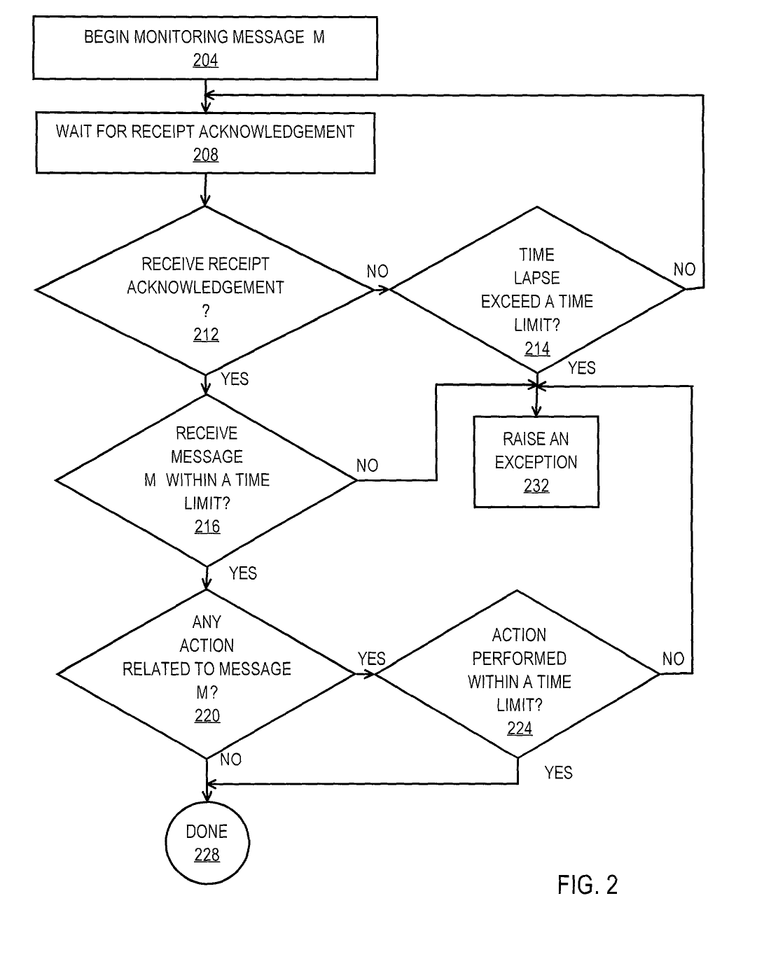

FIG. 2 is a flowchart illustrating that monitor process MP monitors the message being transmitted from one sender partner 108S to one receiving party. A receiving party of the message may be a recipient partner 108R or trusted intermediary 112 if a trusted intermediary is used.

In step 204, as soon as the message was transmitted and thus automatically time-stamped, monitor process MP begins to monitor the message. Monitor process MP in step 208 waits to receive a receipt acknowledgement from each receiving party of the message.

Monitor process MP in step 212 determines whether a receipt acknowledgement has been received. If a receipt acknowledgement has not been received, then monitor process MP in step 214 determines whether the time that has elapsed from the time the message was transmitted exceeds a time limit. If the time lapse does not exceed the time limit, then monitor process MP in step 208 continues to wait to receive the acknowledgment. However, if the time lapse exceeds the time limit, then monitor process MP raises an exception in step 232.

If monitor process MP in step 212 determines that a receipt acknowledgment has been received, then monitor process MP in step 216 determines whether the message was received within a time limit that is allowed from the time the message was transmitted to the time the message must be received at a receiving site. If the message was not received within a time limit, then monitor process M in step 232 raises an exception. However, if the message was received within a time limit, then monitor process MP in step 220 determines whether there are any actions related to the message that must be performed, i.e., whether the message will be consumed. If there is no action, then monitor process MP ends in step 228. However, if there is additional action to be performed, then monitor process MP in step 224 determines whether the action is performed within a time limit, which is the time the message was transmitted to the time the action must be performed. If the action is performed within a time limit then monitor process MP ends in step 228. In contrast, if the action is not performed within a time limit, then monitor process MP in step 232 raises an exception.

### Time Divergence Resolution

Currently, in electronic message communications, a time lapse between the time that the message is transmitted and the time that the message is received should be minimal. However, there may be some discrepancies in time used between a sending partner 108S and a recipient partner 108R, especially in their computer systems. Time divergence resolution techniques are therefore provided. In one embodiment, each of the partners 108 defines a threshold difference in time, so that, if there is any time difference, a recipient partner 108R may take appropriate actions regarding the message. For example, if (1) it is agreed that the time difference threshold between the sender's computer and the recipient's computer is fifteen minutes, and (2) from the time-stamp embedded in the message, it is determined that the time difference between the sender's computer and the recipient's computer is two minutes, then the recipient accepts the message. However, if the time difference is one hour, which is beyond the allowable time divergence, then the recipient can reject the message. As discussed above, in one embodiment, all partners use a predefined time base (e.g., the Greenwich Mean Time), and the time-stamp embedded in the message also uses this predefined time base. Consequently, if the time used by the recipient is not based on the predefined time base, then the recipient converts the recipient's time into the predefined time base to calculate the time divergence.

### Method Steps Illustrating One Embodiment Of The Inventive Techniques

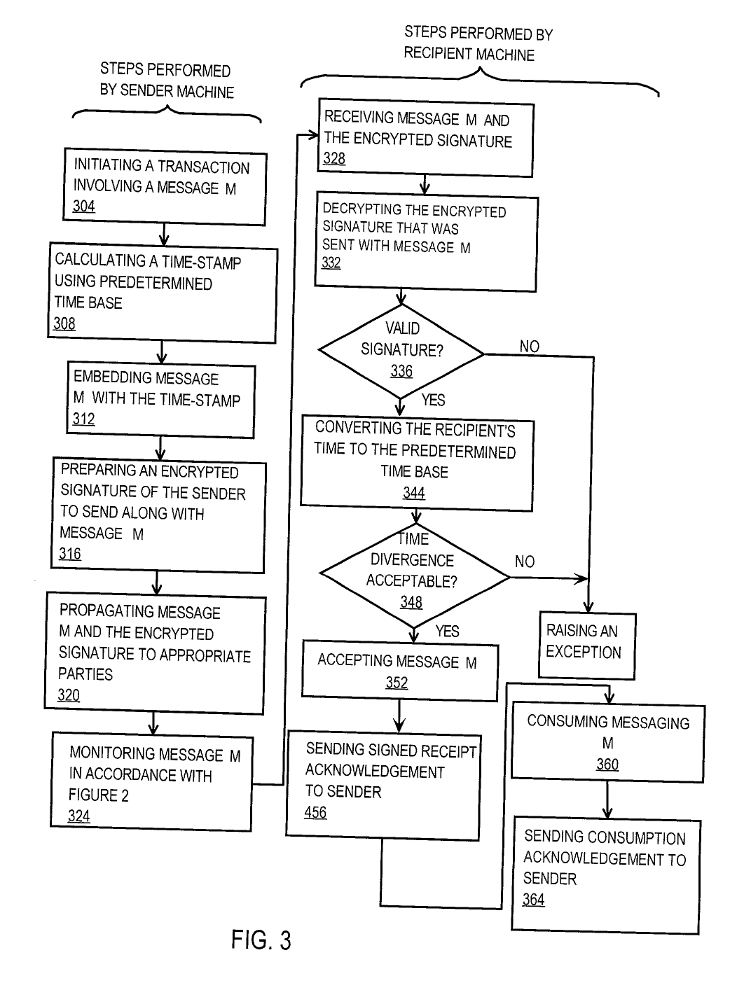

FIG. 3 is a flowchart illustrating one embodiment of the inventive techniques. In this embodiment all transactions are automated using computers of appropriate parties, e.g., sender partners 108S, recipient partners 108R, and trusted intermediary 112. These computers are networked using various technologies including, for example, the Internet, the Ethernet, WAN, LAN, etc. It is stipulated, however, that the invention is not limited to any one of the network technologies. The invention is not limited to any type of computers either. Any computers that can perform the appropriate functions described herein are sufficient.

### I) At The Sending Site

In step 304 a sender partner 108S initiates a transaction involving a message.

In step 308 a time-stamp is automatically calculated to convert the time of sender partner 108S to the predetermined time base (e.g. GMT, in one embodiment). Those skilled in the art will recognize that if sender partner 108S uses the GMT time base, then calculating the time-stamp in the GMT is not necessary.

In step 312 the message is embedded with the time-stamp.

In step 316 a digital signature of sender partner 108S is prepared to send along with the message.

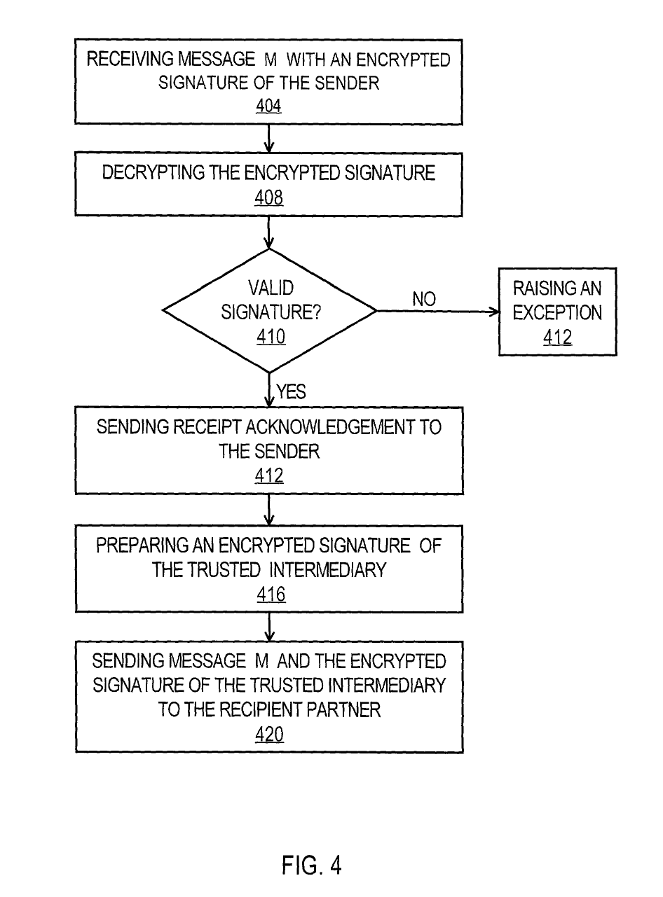

In step 320 the message is propagated to appropriate parties, e.g., directly to recipient partners 108R if trusted intermediary 112 is not used, or to trusted intermediary 112 if trusted intermediary 112 is used (e.g., FIG. 4 below).

In step 324, as soon as the message is propagated in step 320, monitor process MP monitors the message, which was described above in the section “MONITORING THE MESSAGE” and with reference to FIG. 2.

### II) At the Receiving Site

In step 328, the message is received at a site of a recipient partner 108R. In one embodiment, the message may be sent to, and thus received at, various recipient partners 108R.

In step 332, the digital signature is decrypted, e.g., with a public signature decryption key to verify the authenticity of the sender.

In step 336 it is determined that whether sender partner 108S is an authentic sender.

If the sender is not an authentic sender, then an exception is raised in step 340.

However, if the sender is an authentic sender, then a calculation to convert the time of recipient partner 108R to the GMT time base is performed in step 344.

In step 348, based on the time-stamp embedded in the message, and the calculated GMT time of the recipient partner 108R, it is determined whether a time divergence is acceptable.

If the time divergence is not acceptable then an exception is raised in step 340.

However, if the time divergence is acceptable, then the message is accepted in step 352.

In step 356 a receipt acknowledgement is sent to sender partner 108S. According to one embodiment, the receipt acknowledgement is also signed using the same technique as that used to sign the message.

In step 360 the message is consumed.

In step 364 a consumption acknowledgement is sent to sender partner 108S.

### III) At The Intermediary Site

In one embodiment, trusted intermediary 112 may be used to provide additional services to partners 108. Trusted intermediary 112 also relays the messages from sender partners 108S to (and from) recipient partners 108R.

FIG. 4 is a flowchart illustrating the steps in which trusted intermediary 112 receives and relays a message.

In step 404 the message along with a digital signature of sender partner 108S are received at trusted intermediary 112. Those skilled in the art will recognize that this step follows step 324 of FIG. 2.

In step 408 the digital signature was decrypted to verify that the message indeed originates from an authentic sender 108S.

In step 410, it is determined whether the message indeed originates from an authentic sender.

If the message does not originate from an authentic sender 108S then an exception is raised in step 412.

If the message indeed originates from an authentic sender 108S, then a receipt acknowledgement is sent to sender partner 108S in step 414.

In step 416 a digital signature of trusted intermediary 112 is prepared to send along with the message to appropriate recipient partners 108R.

In step 420 the message and the digital signature of trusted intermediary 112 are sent to appropriate recipient partners 108R. Those skilled in the art will recognize that this step 420 precedes step 328 in FIG. 2.

### Hardware Overview

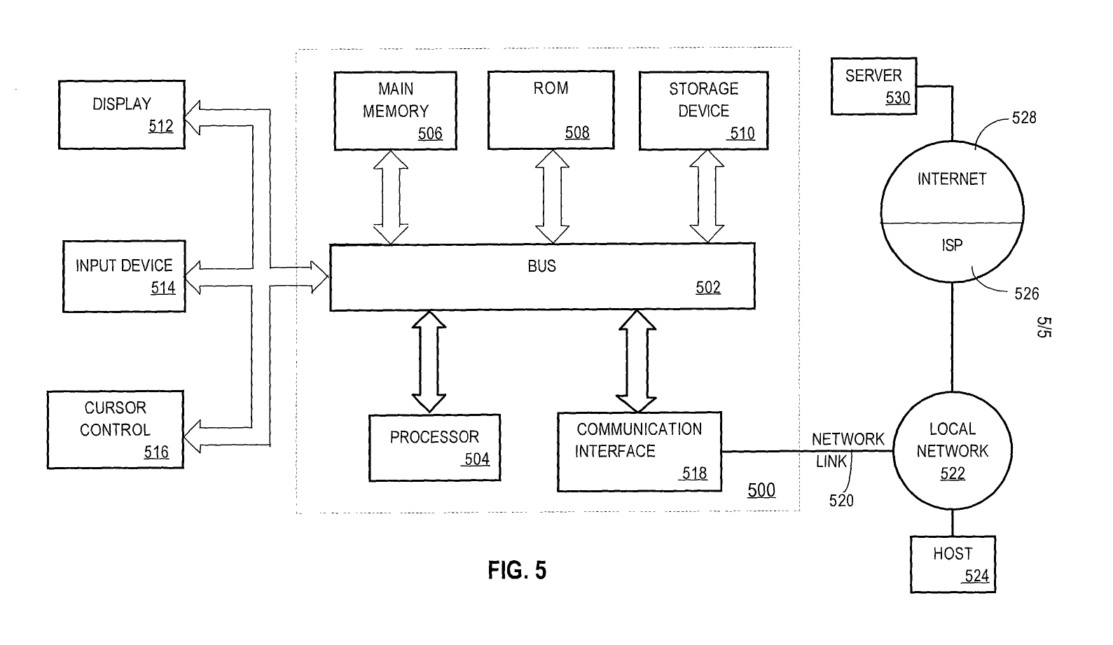

FIG. 5 is a block diagram that illustrates a computer system 500 upon which an embodiment of the invention may be implemented. In particular, computer system 500 may be used by members of trading community 100 to implement embodiments of the inventive techniques described above. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are implemented by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send the messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application implements the techniques described herein.

The received code may be executed by processor 504 as it is received, and/or stored in storage device 510, or other non-volatile storage for later execution. In this manner, computer system 500 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for monitoring a set of messages communicated between a plurality of partners, the method comprising the steps of:
for each message in said set of messages, performing the steps of automatically time-stamping said message with a timestamp;
for each of a plurality of actions to be performed on said message, performing the steps of
identifying a time limit within which said message should be acted upon;
determining whether said message is acted upon within said time limit, and
if said message is not acted upon within said time limit, then raising an exception.

2. The method of claim 1 wherein said plurality of actions includes receiving said message at a site of a partner that said message is intended for and completing a transaction related to said message.

3. The method of claim 1 wherein the step of raising an exception involves human intervention.

4. The method of claim 1, further comprising the step of receiving a receipt acknowledgement associated with said message prior to the step of determining if said message is acted upon within said time limit.

5. The method of claim 1 wherein said message is transmitted along with a digital signature of the partner that sent said message to authenticate that the message originates from an authentic partner.

6. The method of claim 1 wherein:
the message is sent by a sender in a first time zone;
the step of automatically time-stamping includes time-stamping the message with a timestamp that reflects time in a base time zone that is different from said first time zone; and
the step of determining whether said message is acted upon within said time limit is performed by comparing times from said base time zone.

7. A method for processing a set of messages communicated between a plurality of partners, comprising the steps of:
for each message in said set of messages, performing the steps of
at a first site associated with a sending party, automatically time-stamping said message with a timestamp based on a first clock at said first site;
sending the message from the sending party to a second site associated with a receiving party, said second site having a second clock;
determining, based on said timestamp, whether said message has been received within an allowable time divergence relative to said second clock, and
if said message has been received within an allowable time divergence relative to said second clock, then accepting said message, and
if said message has been received within an allowable time divergence relative to said second clock, then raising an exception.

8. The method of claim 7 wherein raising an exception includes rejecting said message.

9. The method of claim 7 wherein:
the first clock reflects time in a first time zone;
the second clock reflects time in a second time zone;
the step of automatically time-stamping includes time-stamping the message with a timestamp that reflects time in a base time zone that is different from at least one of said first time zone and said second time zone; and
the step of determining whether said message has been received within an allowable time divergence relative to said second clock is performed by comparing times that reflect said base time zone.

10. A computer-readable medium bearing instructions for monitoring a set of messages communicated between a plurality of partners, the computer-readable medium bearing instructions for performing the steps of:
for each message in said set of messages, performing the steps of
automatically time-stamping said message with a timestamp;
for each of a plurality of actions to be performed on said message, performing the steps of
identifying a time limit within which said message should be acted upon;
determining whether said message is acted upon within said time limit, and
if said message is not acted upon within said time limit, then raising an exception.

11. The computer-readable medium of claim 10 wherein said plurality of actions includes receiving said message at a site of a partner that said message is intended for and completing a transaction related to said message.

12. The computer-readable medium of claim 10 wherein the step of raising an exception involves human intervention.

13. The computer-readable medium of claim 10, further comprising instructions for performing the step of receiving a receipt acknowledgement associated with said message prior to the step of determining if said message is acted upon within said time limit.

14. The computer-readable medium of claim 10 wherein said message is transmitted along with a digital signature of the partner that sent said message to authenticate that the message originates from an authentic partner.

15. The computer-readable medium of claim 10 wherein:
the message is sent by a sender in a first time zone;
the step of automatically time-stamping includes time-stamping the message with a timestamp that reflects time in a base time zone that is different from said first time zone; and
the step of determining whether said message is acted upon within said time limit is performed by comparing times from said base time zone.

16. A computer-readable medium bearing instructions for processing a set of messages communicated between a plurality of partners, the computer-readable medium including instructions for performing the steps of:
for each message in said set of messages, performing the steps of
at a first site associated with a sending party, automatically time-stamping said message with a timestamp based on a first clock at said first site;
sending the message from the sending party to a second site associated with a receiving party, said second site having a second clock;
determining, based on said timestamp, whether said message has been received within an allowable time divergence relative to said second clock, and
if said message has been received within an allowable time divergence relative to said second clock, then accepting said message, and
if said message has been received within an allowable time divergence relative to said second clock, then raising an exception.

17. The computer-readable medium of claim 16 wherein raising an exception includes rejecting said message.

18. The computer-readable medium of claim 16 wherein:
the first clock reflects time in a first time zone;
the second clock reflects time in a second time zone;
the step of automatically time-stamping includes time-stamping the message with a timestamp that reflects time in a base time zone that is different from at least one of said first time zone and said second time zone; and
the step of determining whether said message has been received within an allowable time divergence relative to said second clock is performed by comparing times that reflect said base time zone.
